(19) United States
(12) Patent Application Publication
(10) Pub. No.: US 2014/0289295 A1
(43) Pub. Date: Sep. 25, 2014

(54) METHOD FOR GENERATING A RANDOM OUTPUT BIT SEQUENCE

(71) Applicants: Matthew LEWIS, Reutlingen (DE); Eberhard BOEHL, Reutlingen (DE); Klaus DAMM, Reutlingen (DE)

(72) Inventors: Matthew LEWIS, Reutlingen (DE); Eberhard BOEHL, Reutlingen (DE); Klaus DAMM, Reutlingen (DE)

(73) Assignee: Robert Bosch GmbH, Stuttgart (DE)

(21) Appl. No.: 14/222,183

(22) Filed: Mar. 21, 2014

(30) Foreign Application Priority Data
Mar. 22, 2013 (DE) 10 2013 205 168.9

(51) Int. Cl. G06F 7/58

(52) U.S. Cl. CPC G06F 7/584
USPC 708/250

(57) ABSTRACT

A method and a device for generating a random output bit sequence are put forth. In the case of these, an input is inputted into a set-up of finite state machines. The set-up ascertains an output on the basis of the input; the input being inputted into the set-up, linked to a one-way function.

### CROSS REFERENCE

The present application claims the benefit under 35 U.S.C. §119 of German Patent Application No. DE 10 2013 205 168.9 filed on Mar. 22, 2013, which is expressly incorporated herein by reference in its entirety.

### FIELD

The present invention relates to a method for generating a random output bit sequence and a device for implementing the method.

### BACKGROUND INFORMATION

Random numbers, which are referred to as the result of random elements, are needed for many applications. So-called random number generators are used for generating random numbers. Random number generators are methods, which supply a sequence of random numbers. A decisive criterion of random numbers is whether the result of the generation can be regarded as independent of earlier results.

In order to generate random bit sequences, random bit generators are used, which deliver a random output bit sequence in response to the inputting of an input bit sequence.

Random numbers are needed, e.g., for cryptographic methods. These random numbers are used, in order to generate keys for the encryption methods. Strict requirements regarding the random characteristics are placed on such keys.

In particular, the amount, that is, the measure of chance, namely, entropy per bit, has to be sufficient. In addition, the bit probabilities for the values from {0, 1} should be equally likely. It should be noted that the random values generated for this by conventional random number sources mostly do not satisfy these requirements. Therefore, additional methods are necessary, which are combined under the term post processing. A DRGB (deterministic random bit generator), as is described, for example, by the Bundesamt für Sicherheit in der Informationstechnik [Federal Office for Security in Information Technology] (BSI) in BSI AIS 31 of Sep. 25, 2001, is typically used for such post processing. Such a generator produces deterministic bit sequences, which, however, appear random. Such generators are also referred to as pseudo-random number generators. If an unknown seed is used as a starting point for the pseudo-random sequence, then this sequence cannot be predictable, even when one knows the bits of the pseudo-random sequence already outputted, but not the seed.

In this connection, the characteristics of a DRBG are being studied more closely, and there are recommendations for a DRBG from the National Institute of Standards and Technology (NIST) in a Special Paper, NIST SP 800-90 from March, 2007.

The conventional post processing is typically carried out, using resilient functions (elastic functions), linear feedback shift registers (LFSR's) and multiple input LFSR's or MISR's (multiple input signature registers).

Conventional methods are either very expensive, such as resilient functions, or they do not exactly satisfy the 50% bit probabilities, such as LFSR's. In addition, the two methods mentioned above do not have the possibility of recognizing errors in the sequence, which may be caused, e.g., by error attacks.

### SUMMARY

An example method is provided for generating a pseudo-random output bit sequence is put forth, in which a set-up of 2ⁿ finite state machines, each of which is identically constructed, is used; the finite state machines each including n status bits; each finite state machine assuming a different state from the other finite state machines of the set-up; on the input side, the finite state machines each being supplied an identical input signal, and as a function of their state, these each generating n signature bits, which together form a signature bit sequence; and the random output bit sequence being generated by selecting individual bits from the signature bit sequences of all of the finite state machines of the set-up.

The example method is carried out, for example, using a pseudo-random bit generator for generating a random output bit sequence having an unknown seed; the pseudo-random bit generator including a set-up of 2ⁿ finite state machines, each of which are identically constructed; the finite state machines each including n status bits; each always assuming a different state from the other finite state machines of the set-up; on the input side, the finite state machines having to be supplied an input signal, and as a function of their state, these each generating n signature bits, which together form a signature bit sequence; and the random output bit sequence being generated by selecting individual bits from the signature bit sequences of all of the finite state machines of the set-up.

In comparison with conventional methods, the example method has the possibility of recognizing error attacks. In addition, it provides a better bit probability than an LFSR. However, this method has the disadvantage that collisions may occur, that is, identical output sequences may occur from different input bit sequences. Attacks of an attacker may be aided by such collisions. In addition, in the method, it is more easily possible to retrace the outputted output signals than in the method, which will now be set forth below.

The method explained above is now expanded, such that the inputs are processed twice, and namely, that they first go directly into the set-up of finite state machines, which is also referred to as a COSSMA set-up (complete set of state machines), and in addition, linked with a one-way function.

In this context, a one-way function is a mathematical function, which is “easily” calculable, but “difficult” to invert.

Direct input ensures that no entropy is lost during processing, and the second linked input helps to prevent collisions, makes retracing or backtracking, that is, calculation of previous output values, more difficult, and makes prediction of future output values more difficult, when the seed is unknown. One may also dispense with direct input, when it can be proven that no entropy is lost in response to linkage with the one-way function, and that the collisions also do not occur more often due to it.

In addition, the effect of all input bits on the output value may be equalized, when a parity is also calculated after the processing of the last input bit and is reflected in the output value.

Additional advantages and embodiments of the present invention are derived from the description below and the figures.

It will be appreciated that the features mentioned above and the features yet to be described below may be used not only in the combination given in each case, but also in other combinations or individually, without departing from the scope of the present invention.

### BRIEF DESCRIPTION OF THE DRAWINGS

FIG. 1 shows the set-up of a variant of the example method put forth.

FIG. 2 shows a specific embodiment of the described device for implementing the described example method.

FIG. 3 shows a set-up of finite state machines.

FIG. 4 shows a 4-bit finite state machine.

FIG. 5 shows state transitions.

FIG. 6 shows a one-way function.

FIG. 7 shows a DRBG output stage.

### DETAILED DESCRIPTION OF EXAMPLE EMBODIMENTS

The present invention is represented schematically in the drawings in light of specific embodiments, and is described in detail below with reference to the figures.

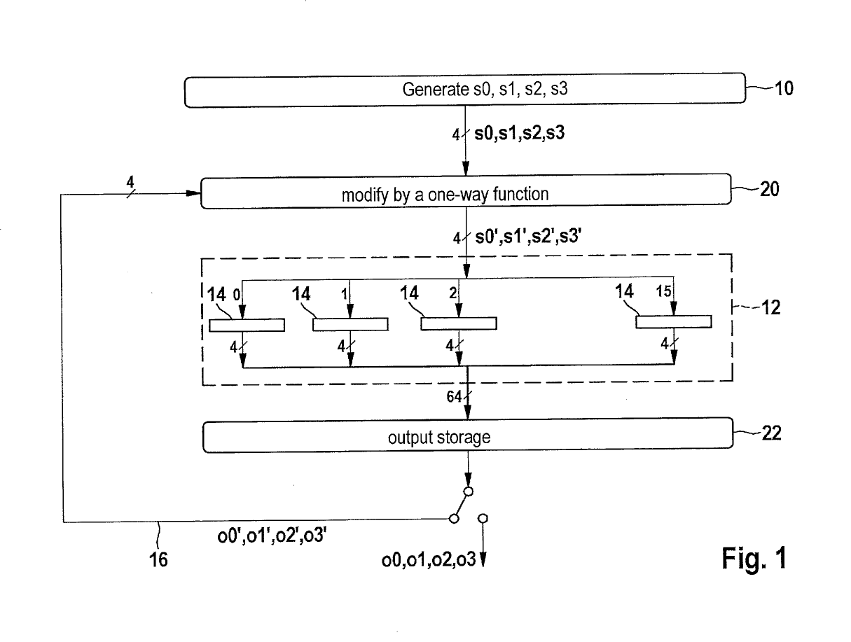

As illustrated in FIG. 1, in a first step 10, in each instance, 4 output bits s0, s1, s2, s3 are generated on the basis of 64 input bits, which are referred to as a seed. This seed is selected and may be, for example, the output of a TRNG source. After the 4 output bits are calculated, this seed is increased by one by a built-in incrementer, and this incremented seed is used for generating the next 4 output bits. This procedure is continued until a new seed is selected. In the first step, the first 4 bits are initially selected from the 64-bit input and immediately applied to the finite-state machine set-up 12 having 16 finite state machines 14.

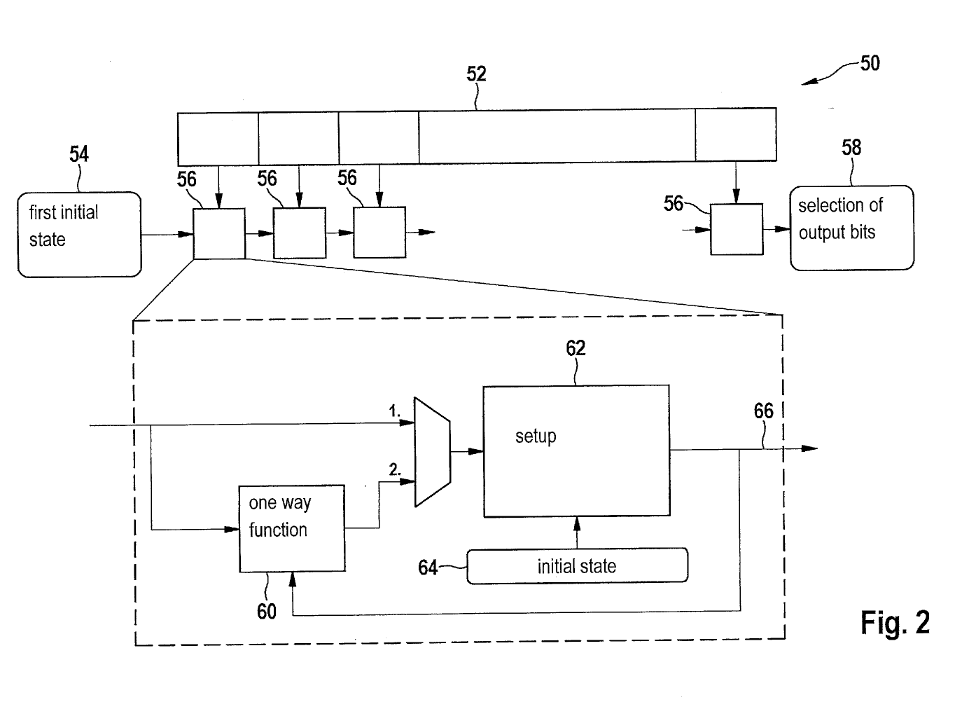

The function of the finite-state machine set-up is explained in FIGS. 2, 3 and 4.

FIG. 2 shows a lay-out of a device for implementing the method, the overall device being designated by reference numeral 50. The illustration shows an input vector 52, which is subdivided into blocks of 4 bits, a first initial state 54, which resets internal counters of the set-up, which become operative for the selection of output bits 58 in connection with the values of input vector 52. In addition, the illustration shows a one-way function 60, a set-up 62 of finite state machines (COSSMA), on which a second initial state 64 acts, which either is active prior to each new processing of an input vector 52 or also first determines the initial state of the finite state machines present in set-up 62 after a predetermined number of input vectors 52. Consequently, after processing the input twice, a value is produced at output 66 of set-up 62.

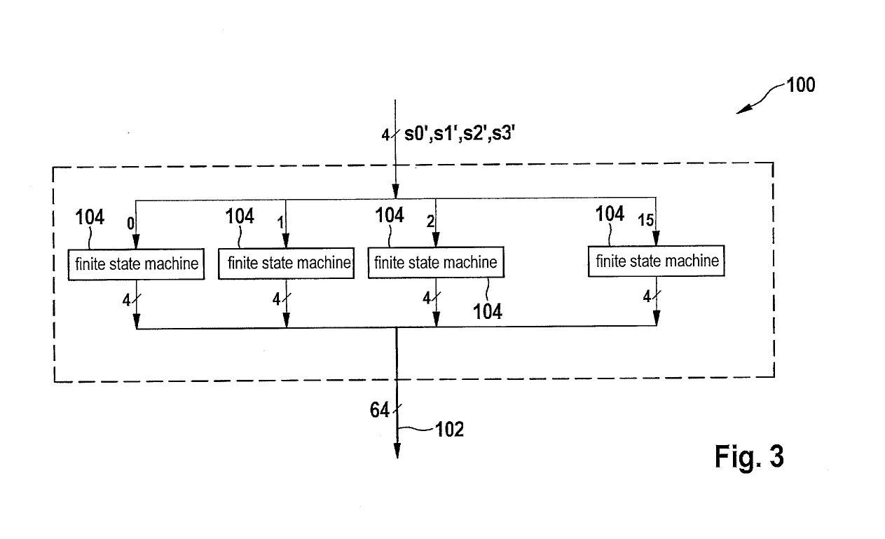

FIG. 3 illustrates a set-up of finite state machines, which is designated, altogether, by reference numeral 100, and which is also referred to as a complete set of finite state machines (COSSMA: COmplete Set of State MAchines). Thus, FIG. 3 shows a complete set of finite state machines corresponding to set-up 12 in FIG. 1.

This set-up 100 has a 4-bit input s0′, s1′, s2′, s3′ and a 64-bit output 102. The bits of output 102 are operated by flipflops of finite state machines 104.

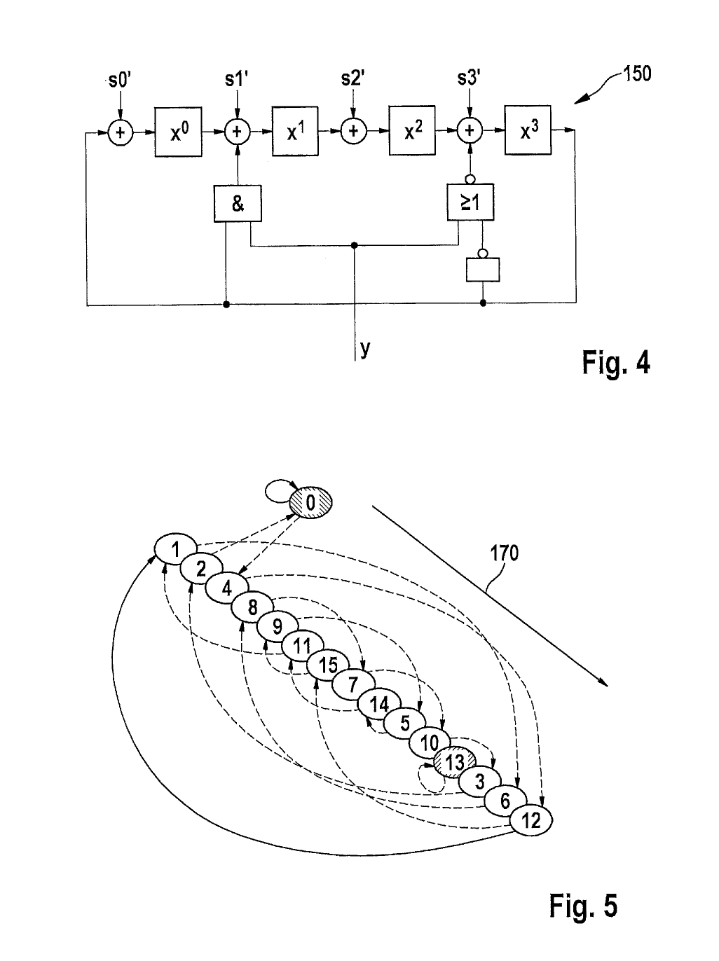

FIG. 4 shows a 4-bit finite state machine, which is designated by reference numeral 150 and is implemented in the form of a 4-bit NLMISR (non-linear multiple input signature register).

Any finite state machine may also be used in place of the NLMISR from FIG. 4, when in each instance, the follow-up state and the predecessor state are uniquely determined for any selected input sequence.

The transfer function of the circuit from FIG. 4 is indicated in the following table.

| Follow-up State of the Flipflop | |
|---|---|
| xi | Equation |
| x⁰ | =s′ (0) ⊕ x³ |
| x¹ | =s′ (1) ⊕ x⁰ ⊕ yx³ |
| x² | =s′ (2) ⊕ x¹ |
| x³ | =s′ (3) ⊕ x² ⊕ /yx³ |

The input bits of all 16 NLMISR's are, in each instance, identical. However, their initial state is different. Thus, according to the aforementioned condition, each NLMISR has, at each instant, a different state from every other NLMISR.

State transitions of the utilized finite state machines, when s0′=s1′=s3′=0, are illustrated in FIG. 5. A solid arrow shows a transition for s2′=0; in this case, a direct transition diagonally to the right, down below, via the respective intermediate states for, in each case, one clock pulse also being possible, as indicated on the right by arrow 170. A dashed arrow stands for s2′=1.

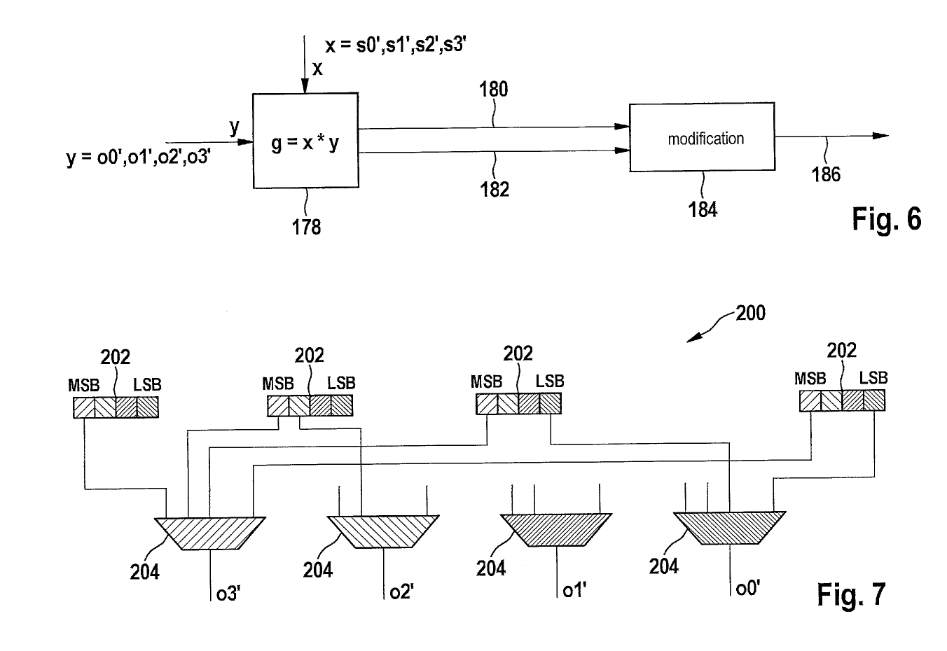

FIG. 6 illustrates a one-way function g=x*y including an input nibble x and feedback of intermediate output y as input variables. This produces a higher nibble 180 of g and a lower nibble 182 of g, which are subjected to a modification 184 so as to obtain a result 186.

Table 1 depicts a result table, which represents a one-way function:

TABLE 1

| | y | | | | | | | | | | | | | | | |
|---|---|---|---|---|---|---|---|---|---|---|---|---|---|---|---|---|
| x | 0 | 1 | 2 | 3 | 4 | 5 | 6 | 7 | 8 | 9 | a | b | c | d | e | f |
| 0 | 2 | 1 | 0 | 15 | 14 | 13 | 12 | 11 | 10 | 9 | 8 | 7 | 6 | 5 | 4 | 3 |
| 1 | 1 | 2 | 3 | 4 | 5 | 6 | 7 | 8 | 9 | 10 | 11 | 12 | 13 | 14 | 15 | 0 |
| 2 | 0 | 3 | 5 | 7 | 9 | 11 | 13 | 15 | 1 | 2 | 4 | 6 | 8 | 10 | 12 | 14 |
| 3 | 15 | 4 | 7 | 10 | 13 | 0 | 2 | 5 | 8 | 11 | 14 | 1 | 3 | 6 | 9 | 12 |
| 4 | 14 | 5 | 9 | 13 | 1 | 4 | 8 | 12 | 0 | 3 | 7 | 11 | 15 | 2 | 6 | 10 |
| 5 | 13 | 6 | 11 | 0 | 4 | 9 | 14 | 2 | 7 | 12 | 1 | 5 | 10 | 15 | 3 | 8 |
| 6 | 12 | 7 | 13 | 2 | 8 | 14 | 3 | 9 | 15 | 4 | 10 | 0 | 5 | 11 | 1 | 6 |
| 7 | 11 | 8 | 15 | 5 | 12 | 2 | 9 | 0 | 6 | 13 | 3 | 10 | 1 | 7 | 14 | 4 |
| 8 | 10 | 9 | 1 | 8 | 0 | 7 | 15 | 6 | 14 | 5 | 13 | 4 | 12 | 3 | 11 | 2 |
| 9 | 9 | 10 | 2 | 11 | 3 | 12 | 4 | 13 | 5 | 14 | 6 | 15 | 7 | 0 | 8 | 1 |
| a | 8 | 11 | 4 | 14 | 7 | 1 | 10 | 3 | 13 | 6 | 0 | 9 | 2 | 12 | 5 | 15 |
| b | 7 | 12 | 6 | 1 | 11 | 5 | 0 | 10 | 4 | 15 | 9 | 3 | 14 | 8 | 2 | 13 |
| c | 6 | 13 | 8 | 3 | 15 | 10 | 5 | 1 | 12 | 7 | 2 | 14 | 9 | 4 | 0 | 11 |
| d | 5 | 14 | 10 | 6 | 2 | 15 | 11 | 7 | 3 | 0 | 12 | 8 | 4 | 1 | 13 | 9 |
| e | 4 | 15 | 12 | 9 | 6 | 3 | 1 | 14 | 11 | 8 | 5 | 2 | 0 | 13 | 10 | 7 |
| f | 3 | 0 | 14 | 12 | 10 | 8 | 6 | 4 | 2 | 1 | 15 | 13 | 11 | 9 | 7 | 5 |

FIG. 7 shows a DRBG output stage, the whole of which is denoted by reference numeral 200. The illustration shows a series of finite state machines 202, which are connected to multiplexers 204. Output stage 200 delivers an intermediate output, which is used for feedback and a final output.

The present invention is explained below with the aid of the figures:

The distribution 0, 1, 2, 3, . . . 15 may be selected as the initial state of finite-state machine set-up 12, 62, 100. Every identically constructed finite state machine 14 has a different initial state. This initial state does not have to be secret, but it may also be treated as a secret state for special applications. A function is then available, which would be comparable to the so-called keyed hash functions that have additional, improved cryptographic characteristics.

In accordance with the input nibbles s0, s1, s2, s3 used, for the first step 10 identical to s0′, s1′, s2′, s3′ and the step number i=0, according to FIG. 7, the 4 internal counters z0 . . . z3 are determined, which determine a selection of 4 bits from finite state machine 202 from finite-state machine set-up 100 according to FIG. 3. In this context, finite-state machine set-up 100 has already been modified by the first input nibble in accordance with FIGS. 3 and 4. These 4 bits represent the intermediate output feedback values, which are shown in FIG. 1, using the reference numeral 16. Using these values, after the first input step, in a second step 20, the same input nibble is modified by a one-way function, which is described in FIG. 6. This modification is defined in Table 1.

Using first input nibble s0, s1, s2, s3 as a first operand and intermediate output o0′, o1′, o2′, o3′, which comes from an output stage 22 that makes a selection of 4 bits, as a second operand, one obtains, for the one-way function, the output: result=s0′, s1′, s2′, s3′, which differs from s0, s1, s2, s3 by a permutation according to Table 1. This output is applied to finite-state machine set-up 12. In this manner, all 64 input bits are each used twice, one after another, as nibbles, namely, without and with a one-way function.

In each instance, after a particular number of input steps, for example, 5, a parity step is inserted. Inputs si′ of the previous five input steps are used, in each instance, to form a serial parity, which is inserted in the following step. In the exemplary embodiment, an even parity is generated from LSB s0″, and an odd parity is generated for each of all of the other bits. The parity should be an odd parity for an odd number of input bits and an even parity for the remaining inputs. This is determined by the different initial state of the flipflops. By applying the parities to set-up 12, 62, 100, it is ensured that the switchover signal for the polynomial y (according to FIG. 4) differs at least once for these six steps.

The switchover signal is explained in greater detail, for example, in German Patent Application No. DE 10 2009 000 322 A1. This causes nonlinearity, since a different polynomial of the NLMISR is selected as a function of the input signals.

The insertion of a parity may also be omitted, if the one-way function has characteristics that render a changeover of the polynomial likely for any input sequences.

After all of the inputs have been processed, the intermediate outputs for three further steps are used directly as inputs for set-up 12, in order to finally still terminate the processing cycle of a 64-bit vector with a parity. If occasion arises, one may also dispense with these additional steps.

In each instance, the seed is incremented after the generation of a 4-bit output value o0, o1, o2, o3, after the processing of all 64 input bits, and using this modified seed, 4 additional bits are generated according to the same method. In each instance, after the generation of, e.g., a total of 128 output bits, the state of set-up 12, 62, 100 is reset to initial state 64. In contrast, initial state 54 for selection counters z0 to z3 is advantageously assumed after each processing of an input vector 52. Instead of incrementing it, the seed may also be decremented, incremented according to a code table, translated, rotated or otherwise modified.

The state of set-up 12, 62, 100 may be checked using different methods. This is possible, since in set-up 12, 62, 100, every finite state machine has a different state at each instant. In addition, the method may be subjected to a test. The different states are ensured by the fact that at the beginning, all of the finite state machines are initialized to different starting values. Due to the substantially identical action of the inputs having a unique successor and predecessor, no equal state may be obtained in two finite state machines.

If the above-mentioned condition no longer applies due to an attack or due to a transient error, such as a soft error caused by cosmic radiation, then this error is detected and suitable measures may be taken, such as a reset.

In the method described above, any other one-way function may also be used in place of the described multiplication. Such one-way functions include, for example, the discrete exponential function, the Rabin function (×2 mod N) or a hash function.

In addition, one may dispense with inserting parities and also omit the three additional steps including a direct application of the intermediate outputs to set-up 12, 62, 100. This may be advantageous for applications having less strict requirements; the nonlinearity of the one-way function is possibly already sufficient for satisfying the corresponding requirements. It is also possible to avoid processing each input nibble twice and to supply only the signals generated by the one-way function to set-up 12, 62, 100.

The device put forth may include an input signal, an output signal, a first circuit that implements a one-way function, and a second circuit that contains a plurality of finite state machines constructed substantially identically. The input signal is linked to the first input of the first circuit, the output of the first circuit is connected to the input of the second circuit, and the output of the second circuit is linked to the output signal.

In addition, the output of the second circuit may be connected to a second input of the first circuit.

The second circuit may be constructed of 2ⁿ substantially identically constructed finite state machines, which each have an n-bit state, all possess a different initial state, and are all linked to the input signals of the second circuit in the same manner.

The one-way function may be implemented by multiplying the two inputs, the double bit width of the result of this multiplication being restored to the single bit width, using combinations between higher-value and lower-value bits of the result.

In addition, the input signal may be made up of a plurality of bits, which are processed in a plurality of steps, in the second circuit. In this context, these parts are, first of all, connected directly and/or indirectly to the input of the second circuit, via the first circuit (one-way function); and after each step, a value is provided at the output of the second circuit for connection to the second input of the first circuit; the value being a selection of the status bit of the finite state machines, which means that such a selection is available at the output of the circuit arrangement after completion of all steps.

After a particular number of steps, a parity may be inserted for each input bit of the second circuit; the parity being formed from the signal values of the respective bit of the preceding steps.

Furthermore, after an output signal is provided, the input signal may be modified, for example, incremented, decremented or changed according to a code rule, and this modified input signal may be used for generating a further output signal.

After a particular number of output values are provided, the finite state machines may be initialized in such a manner, that each finite state machine has a different state.

After a fixed or variable number of modifications, the input signal may be replaced with an unpredictable value.

What is claimed is:

1. A method for generating a random output bit sequence, comprising:
inputting an input into a set-up of finite state machines; and
ascertaining, by the set-up, an output based on the input;
wherein the input that is input into the set-up is linked to a one-way function.

2. The method as recited in claim 1, wherein the input is additionally input directly into the set-up.

3. The method as recited in claim 1, wherein the set-up includes 2ⁿ finite state machines which are each identically constructed, the finite state machines each include n status bits; each of the finite state machines always assumes a different state from the other finite state machines of the set-up; on an input side, the finite state machines are each supplied an identical input signal, and as a function of their state, each generate n signature bits, which together form a signature bit sequence, and the random output bit sequence is generated by selecting individual bits from the signature bit sequences of all of the finite state machines of the set-up.

4. The method as recited in claim 1, wherein in several steps, in each instance, an input is inputted into the set-up, linked to the one-way function.

5. The method as recited in claim 4, wherein in each instance, a parity is inserted into the input after a particular number of input steps.

6. The method as recited in claim 1, wherein a multiplication is used as a one-way function.

7. The method as recited in claim 6, wherein a first operand is multiplied by a second operand, the input being used as the first operand, and an intermediate result of previous operations being used as the second operand.

8. The method as recited in claim 1, wherein an output of a TRNG source is used as an input.

9. A device for generating a random output bit sequence, comprising:
a set-up of finite state machines, the set-up of finite state machines being assigned a one-way function, whose output is assigned to the set-up as an input.

10. The device as recited in claim 9, wherein the set-up of finite state machines includes a set-up of 2ⁿ finite state machines, which are each identically constructed.

11. The device as recited in claim 9, wherein the device includes a TRNG source for providing an input.
